(19) United States
(12) Patent Application Publication
(10) Pub. No.: US 2020/0406380 A1
(43) Pub. Date: Dec. 31, 2020

(54) CUTDOWN MACHINE FOR ROLLER BLINDS

(71) Applicant: SUDU IP PTY LTD., Victoria (AU)

(72) Inventors: Alex LIU, Victoria (AU); Yi LIU, Victoria (AU)

(21) Appl. No.: 16/976,059

(22) PCT Filed: Feb. 28, 2019
(86) PCT No.: PCT/AU2019/050175

§ 371 Date: Aug. 26, 2020

(30) Foreign Application Priority Data
Feb. 28, 2018 (AU) 2018900646

(51) Int. Cl. B23D 45/00; E06B 9/40

(52) U.S. Cl. CPC B23D 45/003; E06B 9/40

(57) ABSTRACT

A cutdown machine for a roller blind comprising: a cutting station between a feed station and an output station, wherein the cutting station comprises stationary clamps adjacently upstream and downstream of a cutter to hold and support the roller blind during and after cutting; a feed vacuum chuck and an output vacuum chuck to vacuum swarf during cutting of the roller blind, wherein the feed vacuum chuck is arranged upstream of the cutting station at the feed station, and the output vacuum chuck is arranged downstream of the cutting station at the output station; a heat blade adjacently downstream of the cutter to heat seal cut kerf edges of the roller blind after cutting; and wherein at least the cutter, stationary clamps, and feed vacuum chuck are servo actuated and controlled to automatically sequentially cut the roller blind into a plurality of roller blinds having custom widths.

### FIELD

The present invention relates to cutdown machines for cutting roller blinds down to size.

### BACKGROUND

The present applicant's WO 2017139833, which is hereby incorporated by reference in its entirety, describes standardised intermediate custom (“STIC”) roller blinds capable of being manufactured in fully automated, high volume, low cost, rapid production conditions with ease and simplicity compared to conventional manually assembled roller blinds. STIC roller blinds can advantageously be produced, transported, handled and stored in bulk (or batches) in standard (or stock) widths before being cut down to desired sizes to fit windows by suppliers.

Existing cutdown machines for cutting roller blinds down to size suffer from various drawbacks. They generally leave rough kerf on cut edges of the polymeric woven fabric of the roller blinds that is prone to fraying. In addition, metal swarf (or debris) is produced from cutting through the aluminium roller tubes and base rails of the roller blinds.

A need therefore exists for cutdown machines for roller blinds that avoid or minimise kerf and swarf.

### SUMMARY

According to the present invention, there is provided a cutdown machine for a roller blind comprising fabric wound around a roller tube, the cutdown machine comprising:

a cutting station between a feed station and an output station, wherein the cutting station comprises stationary clamps adjacently upstream and downstream of a cutter to hold and support the roller blind during and after cutting;

a feed vacuum chuck and an output vacuum chuck to hold the roller tube and vacuum swarf during cutting of the roller blind, wherein the feed vacuum chuck is arranged upstream of the cutting station at the feed station, and the output vacuum chuck is arranged downstream of the cutting station at the output station; and

a heat blade adjacently downstream of the cutter to heat seal cut kerf edges of the roller blind after cutting;

wherein at least the cutter, stationary clamps, and feed vacuum chuck are servo actuated and controlled by a controller to automatically sequentially cut the roller blind from a stock width down into a plurality of roller blinds having custom widths.

The cutdown machine may further comprise roller clamps at the feed station to externally rollably support the roller blind before the opposite open ends of the roller tube are internally held and supported by the feed vacuum chuck and the output vacuum chuck.

The heat blade may be servo actuated and controlled by the controller to automatically sequentially heat seal cut kerf edges of the plurality of roller blinds after cutting.

The cutdown machine may further comprise a cutter vacuum inlet adjacently downstream of the cutter.

Each of the feed vacuum chuck, output vacuum chuck and cutter vacuum inlet may be coupled to a vacuum source actuated and controlled by the controller to automatically sequentially vacuum swarf internally of the roller tube and externally of the roller blind during cutting.

The present invention also provides a plurality of roller blinds cut down to size using the cutdown machine described above.

### BRIEF DESCRIPTION OF DRAWINGS

Embodiments of the invention will now be described by way of example only with reference to the accompanying drawings, in which:

FIG. 1 is a front view of a cutdown machine for roller blinds according to an embodiment of the present invention;

FIG. 2 is a section end view of a STIC roller blind suitable for use in the cutdown machine;

FIG. 3 is perspective top view of the cutdown machine;

FIG. 4 is a detail perspective view of a cutting station of the cutdown machine;

FIG. 5 is a detail perspective view of a movable vacuum chuck of the cutdown machine;

FIG. 6 is a detail perspective view of a roller clamp of the cutdown machine; and

FIG. 7 is a detail perspective view of a heat blade of the cutdown machine.

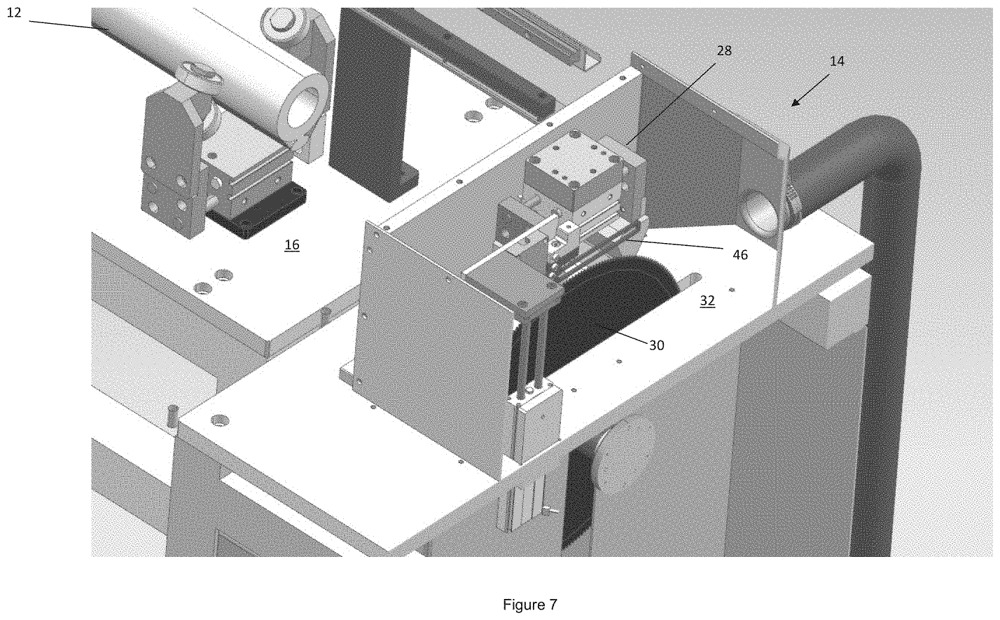

### DESCRIPTION OF EMBODIMENTS

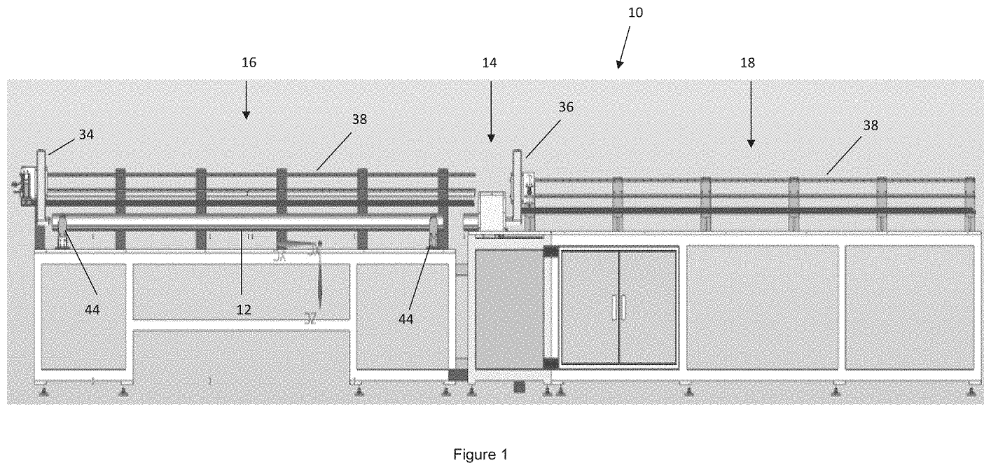

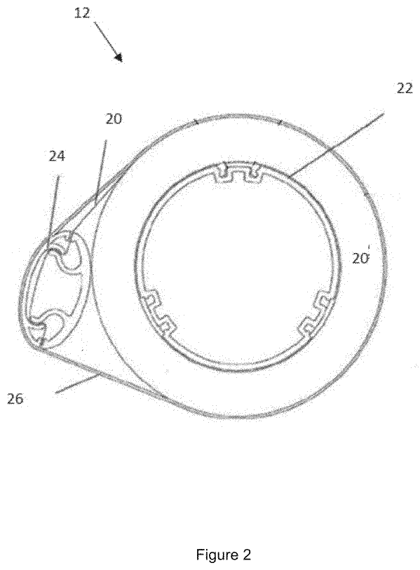

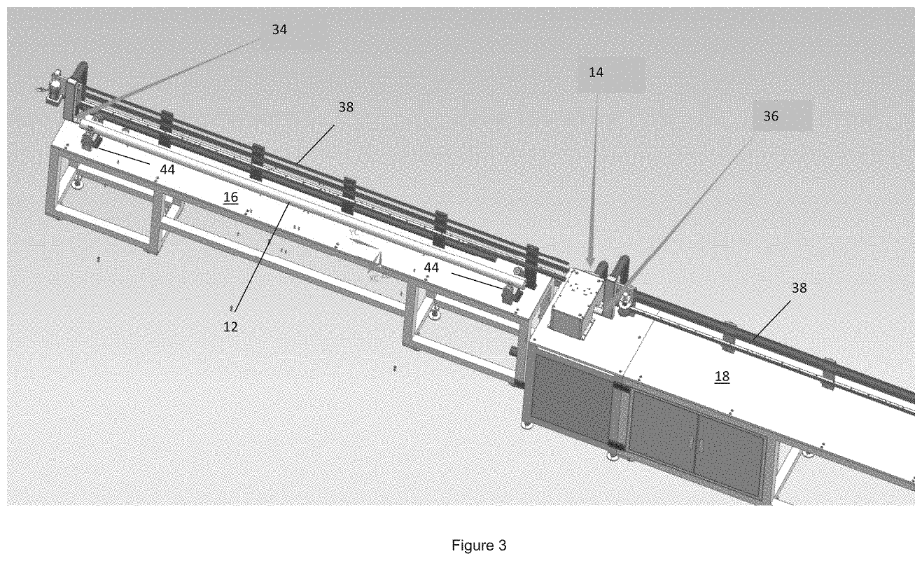

Referring to FIGS. 1 and 3, a cutdown machine 10 for a roller blind 12 according to an embodiment of the present invention may generally comprise a cutting station 14 between a feed station 16 and an output station 18. The feed and output stations 16, 18 may, for example, comprise feed and output tables 16, 18. The roller blind 12 may, for example, comprise a STIC roller blind 12 as described in WO 2017139833 and illustrated in FIG. 2.

The STIC roller blind 12 may generally comprise fabric 20 wound around a hollow aluminium roller tube 22. An aluminium base rail 24 may be attached to a free end of the wound fabric 20. The wound fabric 20 may, for example, comprise a polymeric woven fabric that is prone to fraying when cut. The wound fabric material 20, roller tube 22 and base rail 24 of the STIC roller blind 12 may be wrapped in packaging 26, such as plastic film wrap, for protection, during handling and storage before being cut down to size. Although the cutdown machine 10 is specially adapted to cut STIC roller blinds 12 down to size, it will be appreciated that it may also be used to cut any and all conventional types of roller blinds down to size.

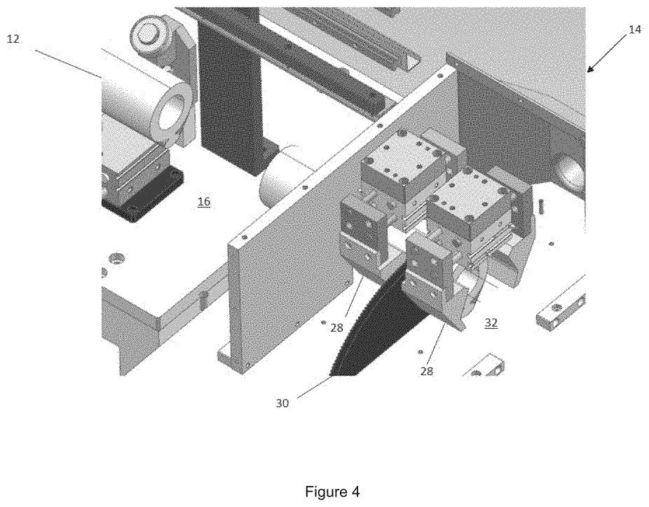

Referring to FIG. 4, the cutting station 14 may comprise two stationary clamps 28 adjacently upstream and downstream of a cutter 30 to hold and support the roller blind 12 during and after cutting. More specifically, the stationary clamps 28 may in use stabilise the STIC roller blind 12 at the point of cut, and prevent it from falling to the surface after cut has been made. The cutter 30 may comprise a circular saw having a saw motor (not shown) that is vertically movable through a slot in a cutting table 32 to cut the roller blind 12.

Referring to FIGS. 1 and 3, the cutdown machine 10 may further comprise a feed vacuum chuck 34 and an output vacuum chuck 36 to internally hold and support opposite open ends of the roller tube 22 and vacuum swarf from the roller blind 12 during cutting of the roller blind 12. The feed vacuum chuck 34 may be arranged upstream of the cutting station 14 on the feed table 16, and the output vacuum chuck 36 may be arranged downstream of the cutting station 14 on the output table 18. The feed vacuum chuck 34 may be horizontally drivable along rails 38 arranged above the feed table 16 to positively feed the roller blind 12 towards the cutting station 14. The output vacuum chuck 36 may be passively horizontally movable along rails 38 arranged above the output table 18 by the feed vacuum chuck 34 to be passively pushed away from the cutting station 14 after cutting of the roller blind 12. The output vacuum chuck 36 may then be servo actuated to move horizontally back into position for the next cutting sequence. It will be appreciated that further or alternative arrangements for supporting the roller blind 12 in the cutting station 14 and/or vacuuming swarf during cutting may also be used. For example, roller blind 12 may be conventionally clamped or held in or about the cutting station 14 while one or more vacuum points remove swarf during cutting.

The feed and output vacuum chucks 34, 36 may be provided at opposite ends of the STIC roller blind 12 to be cut. In use, the active and output vacuum chucks 34, 36: hold the roller blind 12 in place so that it is centred vertically (against gravity) and laterally; push the roller blind 12 into desired horizontal position for cutting; and act as vacuum points at opposite open ends of the roller tube 22 of the roller blind 12.

The feed vacuum chuck 34 on the left side of the feed table 16 is “active” in that it is controlled by a servo to actively move and feed in the roller blind 12 horizontally to the exact position for cutting the roller blind 12 down from a stock width to a custom width. The feed vacuum chuck 34 pushes against the output vacuum chuck 36 on the output table 18 on the right side of the cutting station 14 so that the roller blind 12 may be suspended between the two vacuum chucks 34, 36 when the output vacuum chuck 36 is locked in a fixed position, for example, by an electromagnetic brake (not shown). The output vacuum chuck 36 may also be moved horizontally to disengage the cutdown roller blind 12 after cutting to allow it to be removed from the output table 18. In other embodiments, the output vacuum chuck 36 may be motorised and selectively switched between locked, passive and driven movement by a clutch. During cutting, air is sucked out from both ends of the roller tube 12 through the two vacuum chucks 34, 36.

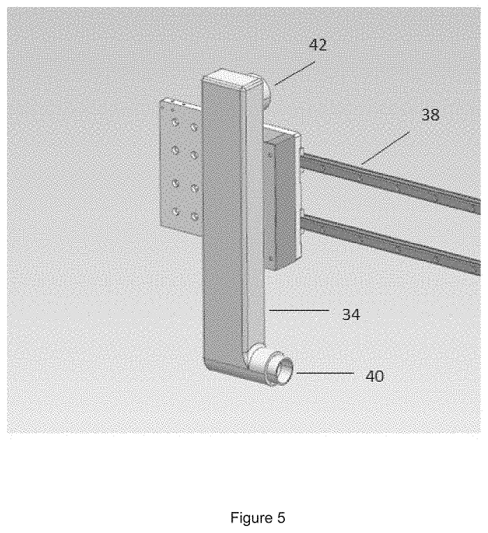

As shown in FIG. 5, the feed vacuum chuck 34 may comprise a vacuum inlet 40 configured to be removably received inside an open end of the aluminium roller tube 22, and a vacuum outlet 42 configured to be coupled to a vacuum source (not shown). The output vacuum chuck 36 may have the same structure and configuration as the feed vacuum chuck 34 except that it is passively movable not drivably movable.

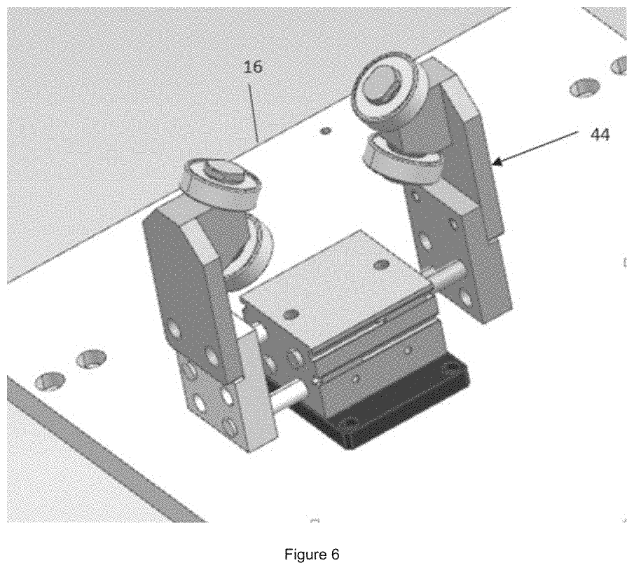

Referring to FIGS. 1, 3, and 6, the cutdown machine 10 may further comprise two roller clamps 44 spaced apart from one another at opposite ends of the feed table 16 to externally rollably support the roller blind 12 before the opposite open ends of the roller tube 22 are internally held and supported by the feed vacuum chuck 34 and the output vacuum chuck 36. The roller clamps 44 may be used to hold a new STIC roller blind 12 in place on the feed table 16 before it can be suspended by the vacuum chucks 34, 36. The vertical and lateral centres of the roller clamps 44 may be aligned to those of the vacuum chucks 34, 36. Similarly, the stationary clamps 28 on each side of the cutter 30 may also have their vertical and lateral centres aligned to those of the vacuum chucks 34, 36.

Each of the cutter 30, stationary clamps 28, roller clamps 44, feed vacuum chuck 34, and output vacuum chuck 36 may be servo actuated and controlled by a controller (not shown) to sequentially cut the roller blind 12 down into a plurality of roller blinds 12₁₋ₙ. These components may be servo actuated by electrical, hydraulic and/or pneumatic servo motors, servomechanisms or servo systems.

The cutdown machine 10 may further comprise a heat blade 46 adjacently downstream of the cutter 30 to heat seal cut kerf edges of each roller blind 12₁₋ₙ after cutting. The heat blade 46 may have a width that matches a width of a cutting blade of the cutter 30. The fabric 20 of the roller blind 12 may, for example, be a polymeric fabric having a predetermined optimum heat sealing temperature. The heat blade 46 may be controlled by a thermistor at a heat sealing temperature that corresponds to the predetermined optimum heat sealing temperature of the fabric 20 of the roller blind 12.

The heat blade 46 may also be servo actuated, for example, by a pneumatic servo motor, and controlled by the controller to sequentially heat seal cut kerf edges of the plurality of roller blinds 12₁₋ₙ, after cutting.

The cutdown machine 10 may further comprise a cutter vacuum inlet (not shown) adjacently downstream of the cutter 30 in the cutting station 14. The cutter vacuum inlet may also be coupled to the same vacuum source that is coupled to the feed and output vacuum chucks 34, 36. The vacuum source may be actuated and controlled by the controller so that the feed and output vacuum chucks 34, 36 and the cutter vacuum inlet collectively vacuum swarf internally of the roller tube 22 and externally of the roller blind 12 during sequential cutting.

Embodiments of the present invention may partially or fully automated to cut STIC roller blinds 12 down to size. The automatic sequential operation of a fully automated embodiment of the cutdown machine 10 will now be described. A new STIC roller blind 12 may be loaded on the feed table 14 on the left side of the cutting station 14 and may be gradually pushed or fed to the right towards the cutter 30 by the feed vacuum chuck 34 as cuts are made. The roller blind 12 may be manually held in place and supported and on the feed table 16 between the roller clamps 44 in a disengaged state. The roller clamps 44 may then be engaged, locking the roller blind 12 in place but allowing horizontal movement. The feed vacuum chuck 34 may then move to collect the left side open end of the roller tube 22 of the roller blind 12. Next, the left side roller clamp 44 may disengage, because this end is now held up by the left feed vacuum chuck 34. The right side roller clamp 44 may remain engaged at this point so that the other end of the roller blind 12 does not fall onto the surface. The left feed vacuum chuck 34 may then continue pushing the roller blind 12 into an initial cutting position where a sacrificial trim cut may be made.

Next, both stationary clamps 28 may engage to hold the roller blind 12 in place, while the right roller clamp 44 disengages. The right side output vacuum chuck 36 may then be moved up against the right end of the roller blind 12 and an electromagnetic brake may then be engaged to hold the roller blind 12 in place for cutting. The saw blade of the cutter 30 may then start, and the vacuum source may be turned on. The stock width roller blind 12 may then cut down to a custom width with swarf being sucked away from all three vacuum points—ie, through the roller tube 22 via the feed and output vacuum chucks 34, and adjacently from the cutter 30 via the cutter vacuum inlet.

The heat blade may then seal kerf edges of the cutdown roller blind 12. Next, the right stationary clamp 28 may disengage. The electromagnetic brake on right output vacuum chuck 36 may then be disengaged which allows the output vacuum chuck 36 to move away and the sacrificial cut to be removed. Next, the right output vacuum chuck 36 may move back up against the right side of the remainder of the roller blind 12. The left stationary clamp 28 may then disengage so that the roller blind 12 is completely suspended on the two vacuum chucks 34, 36. The left feed vacuum chuck 34 may then move to a first cut position, pushing the roller blind 12 along with the right output vacuum chuck 36. The electromagnetic brake on the output vacuum chuck 36 may then engage to lock the horizontal position of the roller blind 12. Next, both stationary clamps 28 may engage to hold the roller blind 12 in place in preparation for cutting.

The saw blade of the cutter 30 may then be started and the vacuum source turned on. The roller blind 12 is then is cut with swarf sucked away from all three vacuum points. The heat blade may then seals kerf edges. Next, the right stationary clamp 28 may disengage. The electromagnetic brake on right output vacuum chuck 36 may then disengage to allow the output vacuum chuck 36 to move away so that the first cutdown roller blind 12₁ may be removed from the output table 18. Next, the output vacuum chuck 36 may move back up against the right side of the remainder of the roller blind 12. The above steps may then be repeated for remaining cuts on the current roller blind 12 to sequentially produce a plurality of roller blinds 12₂₋ₙ from the original stock width STIC roller blind 12. The cutdown sequence may then be repeated for a plurality of stock width STIC roller blinds 12. The resulting pluralities of custom width roller blinds 12₁₋ₙ may correspond to one or more customer orders that may be supplied to an installer for installation at customer premises.

Optionally, the controller may be further configured to control the sequential cutting and heat sealing of the plurality of custom widths of the stock width STIC roller blind 12 to avoid or minimise material wastage through unnecessary offcuts. For example, one or more customer orders for different custom width roller blinds having different custom widths may be received by the controller, and the controller may calculate a cutting sequence of one or more of the stock width STIC roller blinds 12 based on the required custom widths that avoids or minimises material wastage.

Embodiments of the present invention provide cutdown machines that are both generally and specifically useful for cutting roller blinds down to size in fully automated, high volume, low cost, rapid production conditions with ease and simplicity while avoiding or minimising kerf, swarf and material wastage.

For the purpose of this specification, the word “comprising” means “including but not limited to,” and the word “comprises” has a corresponding meaning.

The above embodiments have been described by way of example only and modifications are possible within the scope of the claims that follow.

1. A cutdown machine for a roller blind comprising fabric wound around a roller tube, the cutdown machine comprising:
a cutting station between a feed station and an output station, wherein the cutting station comprises stationary clamps adjacently upstream and downstream of a cutter to hold and support the roller blind during and after cutting;
a feed vacuum chuck and an output vacuum chuck to hold the roller tube and vacuum swarf during cutting of the roller blind, wherein the feed vacuum chuck is arranged upstream of the cutting station at the feed station, and the output vacuum chuck is arranged downstream of the cutting station at the output station;
a heat blade adjacently downstream of the cutter to heat seal cut kerf edges of the roller blind after cutting; and
wherein at least the cutter, stationary clamps, and feed vacuum chuck are servo actuated and controlled by a controller to automatically sequentially cut the roller blind from a stock width down into a plurality of roller blinds having custom widths.

2. The cutdown machine of claim 1, further comprising roller clamps at the feed station to externally rollably support the roller blind before the opposite open ends of the roller tube are internally held and supported by the movable vacuum chuck and the output vacuum chuck.

3. The cutdown machine of claim 1, wherein the heat blade is servo actuated and controlled by the controller to automatically sequentially heat seal cut kerf edges of the plurality of roller blinds after cutting.

4. The cutdown machine of claim 1, further comprising a cutter vacuum inlet adjacently downstream of the cutter.

5. The cutdown machine of claim 4, wherein each of the feed vacuum chuck, output vacuum chuck and cutter vacuum inlet are coupled to a vacuum source actuated and controlled by the controller to automatically sequentially vacuum swarf internally of the roller tube and externally of the roller blind during cutting.

6. A plurality of roller blinds cut down to size using the cutdown machine of claim 1.
